(19) United States
(12) Patent Application Publication
(10) Pub. No.: US 2014/0376919 A1
(43) Pub. Date: Dec. 25, 2014

(54) Remote Control System and Method

(71) Applicant: Robert P. Stratton, (US)

(72) Inventors: Michael A. Nykoluk, Mississauga (CA); Minh N. Doan, Woodbridge (CA); Dolly Audit, Toronto (CA); Sundeep Madra, Toronto (CA); Michael J. Jarema, Oakville (CA); Sahand Sojoodi, Guelph (CA); Robert P. Stratton, Pickering (CA)

(21) Appl. No.: 14/480,496

(22) Filed: Sep. 8, 2014

Related U.S. Application Data
(62) Division of application No. 12/991,187, filed on Mar. 24, 2011.

(51) Int. Cl. G08C 23/04

(52) U.S. Cl. CPC G08C 23/04; G08C 2200/00
USPC 398/107

(57) ABSTRACT

A remote control system and method for controlling and interacting with a variety of devices and systems is disclosed. The system comprises at least one command server which is operable to receive control commands from a handheld communications device and to generate and transmit command signals in response to the received control commands, the transmitted command signals interacting with one or more devices controlled by the system. In one embodiment, the handheld communications device is operable to exchange data with an account server that maintains data and configuration information for the system and the devices to be controlled by it over a first communications modality. The handheld communications device transfers control commands and other data with the command server via a second communications modality and the handheld communications device can transfer data between the account server and the command server as needed. The system can support multiple devices to be controlled, multiple command servers, which can each be associated with one or more devices to be controlled, and multiple handheld communications devices.

### RELATED APPLICATIONS

This application claims priority from U.S. Provisional Patent Application 61/051,363, filed May 8, 2008 and the contents of this Provisional Application are incorporated herein, in their entirety, by reference.

### TECHNICAL FIELD

The present invention relates to a remote control system and method for controlling and interacting with a variety of devices and systems. More specifically, the present invention relates to a remote control system and method employing a handheld communications device and a command server for wirelessly controlling and interacting with a variety of devices and systems.

### BACKGROUND ART

Remote control systems for various devices and systems are now virtually ubiquitous. For example, garage door openers, television and stereo systems, household ceiling fans, household lighting systems, etc. can all be equipped with wireless remote control units that provide for their remote activation and/or control.

Wireless remote control systems can employ a variety of communications modalities to communicate commands from the handheld control device to the device being controlled. Ultrasonic, radio and infrared (IR) signaling modalities have all been widely used for remote control systems, with IR systems being the most commonly employed due to their relative low cost.

One of the problems experienced with wireless remote control systems was the proliferation of the handheld control units. Specifically, each consumer device to be controlled was typically equipped with its own handheld control unit. Thus to activate a home theatre system, for example, a consumer might be required to interact with three or more different handheld control units, one for the television set, one for the surround sound system and one for the DVD player.

To address this issue, so-called universal remotes were developed. A universal remote can produce commands for more than one device to be controlled and thus can be employed instead of multiple, separate, handheld remotes.

However, a significant problem with universal remotes is that they often did not contain the data required to create appropriate commands for one or more devices that the owner of the universal remote wished to control. As the manufacturer of the universal remote had limited memory within the universal remote control to store commands for devices, the manufacturer could not include all possible commands for all possible devices. Thus, manufacturers of universal remotes were forced to make assumptions as to which commands will be required by the majority of purchasers of their universal remotes. Further, the manufacturer of the universal remote could not include commands for consumer devices which were created after the universal remote was manufactured.

To address these faults with universal remotes, learning universal remotes were created. Learning universal remotes include the capability to learn commands from the remote supplied with the consumer device when those commands were not in the remote's memory when it was manufactured.

While learning universal remote controls were a significant advance over universal remotes they too suffered from problems. For example, many consumers had difficulty in successfully performing the steps required to have their universal remote learn commands from other remotes. Also, in the event that the original remote supplied with the consumer device was not available or was no longer functioning (which was often the reason the consumer purchased the universal remote), the consumer could not have the learning universal remote learn the needed commands.

Another problem with universal and/or learning universal remotes is that the remotes have a limited number of buttons to initiate the transmission of commands and these buttons are labeled, often somewhat arbitrarily, by the manufacturer of the remote and may not correspond well to the device being controlled.

More recently, universal remotes have been created which can be connected, via a USB or other interface, to an Internet connected PC. Such Internet capable remotes can have missing IR commands downloaded into them, via the PC, from a database that the manufacturer of the remote maintains and updates as necessary. While such internet capable remotes do offer advantages over prior remote systems, they also suffer from disadvantages in that the remote must be connected to an internet connected PC and that the update process must be explicitly performed by the user and may be difficult for many consumers to successfully accomplish.

Further, all of the prior art remote control systems discussed above require the user to use one or more dedicated handheld remote control devices. These dedicated handheld remote control devices must be maintained (i.e.—batteries recharged or replaced, etc.) and located where they can be easily found when it is desired to control a device.

### SUMMARY OF THE INVENTION

It is an object of the present invention to provide a novel remote control system and method which obviates or mitigates at least one disadvantage of the prior art.

According to a first aspect of the present invention, there is provided a remote control system for controlling at least one device, comprising: at least one command server operable to receive control commands, the command server being operable to transmit command signals to control the at least one device in response to received control commands; at least one handheld communications device operable to transmit control commands to the at least one command server and to transfer data over a data communications network; and an account server, connected to the data communications network, operable to store configuration information for user accounts defined for the remote control system and to create and transfer configuration data sets over the data communications network to configure each of the at least one command servers and each of the at least one handheld communications device to control the at least one device as desired.

Preferably, the handheld communications device is a smartphone.

According to another aspect of the present invention, there is provided a remote control system for controlling at least one device, comprising: at least one command server operable to receive control commands, the command server being operable to transmit command signals to control the at least one device in response to received control commands, the at least one command server further comprising a multimedia processor with at least one audio output; at least one handheld communications device operable to transmit control commands and data to the at least one command server and to transfer data over a data communications network, the handheld communications device storing at least one digital audio recording and executing a control application to transfer the at least one digital audio recording to the at least one command server and to transmit control commands to the at least one command server to cause the at least one digital audio recording to be played by the multimedia processor and output on the at least one audio output; and an account server, connected to the data communications network, operable to store configuration information for user accounts defined for the remote control system and to create and transfer configuration data sets over the data communications network to configure each of the at least one command servers and each of the at least one handheld communications device to control the at least one device as desired.

Preferably, the handheld communications device stores a plurality of digital audio recordings and the control application further comprises means for selecting which digital audio recording is to be processed by the multimedia processor and the remote control system is operable to transmit control signals to control an audio playback device which receives the at least one audio output.

According to yet another aspect of the present invention, there is provided a remote control system for controlling at least one device, comprising: at least one command server having a first communications modality to receive control commands, the command server being operable to transmit command signals to control the at least one device in response to received control commands; at least one handheld communications device operable to bi-directionally communicate with the command server via said first communication modality to transmit control commands to the at least one command server and further operable to transfer data over a second communications modality to a data communications network; and an account server, connected to the data communications network, operable to store configuration information for user accounts defined for the remote control system and to create and transfer configuration data sets over the data communications network to configure each of the at least one command servers and each of the at least one handheld communications device to control the at least one device as desired.

Preferably, the remote control system comprises at least two command servers and each of the at least two command servers is operable to communicate with another of said at least two command servers via the first communications modality and the at least two command servers function as nodes in a mesh network.

According to yet another aspect of the present invention, there is provided a remote control system for controlling at least one device, comprising: at least one command server having a first communications modality to receive control commands, the command server being operable to transmit command signals to control the at least one device in response to received control commands; at least one handheld communications device operable to transmit control commands to the at least one command server and further operable to transfer data over a second communications modality to a data communications network; and an account server, connected to the data communications network, and including a web server, the account server operable to accept and store configuration information from the web server for user accounts defined for the remote control system and to create and transfer configuration data sets over the data communications network to configure each of the at least one command servers and each of the at least one handheld communications device to control the at least one device as desired.

Preferably, a user of the remote control system can access the web server to cause the account server to send a control command to the at least one command server to control the at least one device.

According to yet another aspect of the present invention, there is provided a remote control system for controlling at least one device, comprising: at least one command server having a first communications modality to receive control commands, the command server being operable to transmit command signals to control the at least one device in response to received control commands; at least one handheld communications device comprising a mobile telephone with an input means and a display, the mobile telephone operable to transmit control commands to the at least one command server and further operable to transfer data over a second communications modality to a data communications network; and an account server, connected to the data communications network the account server operable to accept and store configuration information for user accounts defined for the remote control system and to create and transfer configuration data sets over the data communications network to configure each of the at least one command servers and each of the at least one handheld communications device to control the at least one device as desired and the configuration data set transferred to the mobile telephone further comprises a remote control software application which is executed by the mobile telephone.

Preferably, the input is text information and the corresponding command signals result in the input of the text information into the at least one device and/or wherein the input comprises a haptic device and the remote control software application accepts input from the haptic device and determines the control commands which correspond to the input and transmits the determined control commands to the command server which, in turn, transmits corresponding command signals to the at least one device.

According to yet another aspect of the present invention, there is provided a remote control system for controlling at least one device, comprising: at least one command server operable to receive control commands, the command server being operable to transmit command signals to control the at least one device in response to received control commands; at least one smartphone operable to transmit control commands to the at least one command server and to transfer data over a data communications network; and an account server, connected to the data communications network, operable to store configuration information for user accounts defined for the remote control system and to create and transfer configuration data sets over the data communications network to configure each of the at least one command servers and each of the at least one handheld communications device to control the at least one device as desired and the configuration data set transferred to the smartphone further comprises a remote control software application and a television programming guide which is executed by the mobile telephone.

Preferably, the listings in the programming guide are updated through the data communications network.

According to yet another aspect of the present invention, there is provided a remote control system for controlling at least one device, comprising: at least one command server operable to receive control commands, the command server being operable to transmit command signals to control the at least one device in response to received control commands; at least one smartphone operable to transmit control commands to the at least one command server and to transfer data over a data communications network; and an account server, connected to the data communications network, operable to store configuration information for user accounts defined for the remote control system and to create and transfer configuration data sets over the data communications network to configure each of the at least one command servers and each of the at least one handheld communications device to control the at least one device as desired and the configuration data set transferred to the smartphone further comprises a remote control software application and wherein the remote control application executing on the smartphone can record a series of command selections input by a user, and the relative timing of the series of command selections to create a macro allowing that series of command selections to be repeated as desired.

Preferably, the created macro can be copied to the account server.

The present invention provides a remote control system and method for controlling and interacting with a variety of devices and systems is disclosed. The system comprises at least one command server which is operable to receive control commands from a handheld communications device and to generate and transmit command signals in response to the received control commands, the transmitted command signals interacting with one or more devices controlled by the system. In one embodiment, the handheld communications device is operable to exchange data with an account server that maintains data and configuration information for the system and the devices to be controlled by it over a first communications modality. The handheld communications device transfers control commands and other data with the command server via a second communications modality and the handheld communications device can transfer data between the account server and the command server as needed. The system can support multiple devices to be controlled, multiple command servers, which can each be associated with one or more devices to be controlled, and multiple handheld communications devices.

### BRIEF DESCRIPTION OF THE DRAWINGS

Preferred embodiments of the present invention will now be described, by way of example only, with reference to the attached Figures, wherein:

FIG. 1 shows a schematic representation of a remote control system in accordance with the present invention;

FIG. 2 shows a schematic representation of a command server for use with the remote control system of FIG. 1; and

FIGS. 3a and 3b shows a flow chart representing a method of configuring a remote control system in accordance with the present invention.

### DETAILED DESCRIPTION OF THE INVENTION

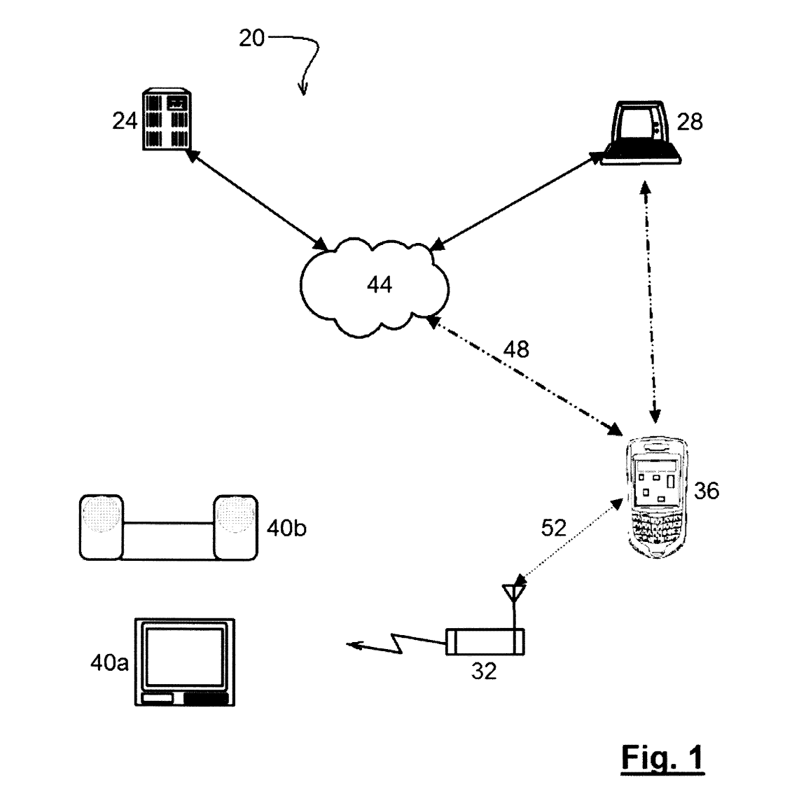

A novel remote control system in accordance with the present invention is indicated generally at 20 in FIG. 1. System 20 includes an account server 24, a customer computer 28, at least one command server 32 and at least one handheld communications device 36. In the illustrated example, system 20 is used to control a television set 40a and an audio receiver 40b. However, the present invention is not limited to controlling these example devices and can instead be used to control almost any device which is capable of being remotely controlled, such as a wide variety of consumer electronics devices, environmental systems such as air conditioning, heating, heating, lighting, drapery openers and home security systems, etc.

Account server 24 can be any suitable data server connected to a data communications network 44, such as Internet or a cellular data packet network. As described in more detail below, account server 24 maintains account information for each user of system 20 as well as maintaining a database of remote control IR commands, RF commands, etc. and other related information.

Customer computer 28 can be any suitable computing device, such as a personal computer running Microsoft Windows, Linux or Apple OS/X which can connect to, and interact with, account server 24 through data communications network 44. In a present embodiment of system 20, the interaction with account server 24 is achieved via a series of html web pages and thus personal computer 28 need only be able to perform web browsing to provide the necessary degree of interaction.

Handheld communications device 36 can be any suitable communications and computing device as will occur to those of skill in the art. Handheld communications device 36 must be capable of communicating with account server 24 (either directly or indirectly, as described below) and must be capable of communicating with command server 32, as described below.

In a presently preferred embodiment of the invention, handheld communication device 36 is a smartphone, such as a Blackberry Curve, manufactured by Research in Motion, or an iPhone manufactured by Apple. While there is no generally accepted standard definition of a smartphone, as used herein the term smartphone is intended to comprise any mobile telephone which can provide data connectivity, an ability to execute software applications, an application display (typically a LCD screen or the like) and an input mechanism (typically a keyboard, touchscreen, trackball, etc).

When handheld communications device 36 is capable of communicating with account server 24 through data communications network 44 and is capable of web browsing and/or otherwise suitably interacting with account server 24, then handheld communications device 36 may also serve as personal computer 28 in the setup and configuration activities further described below.

It is also contemplated that handheld communications device 36 can be connected to personal computer 28, via a USB, WiFi or other local connection, to allow the transfer of data from personal computer 28 to handheld communications device 36 as desired. In such a case, data from account server 24 can be transferred to personal computer 28 via data communications network 44 and then, via a USB, WiFi or other local connection, from personal computer 28 to handheld communications device 36 or vice versa.

Handheld communications device 36 can communicate with account server 24, either directly through data communications network 44, or through data communications network 44 via a local connection to personal computer 28 which is, in turn, operable to communicate with account server 24 through data communications network 44. Further, handheld communications device 36 provides at least a second data communication modality with command server 32.

In the presently preferred embodiment wherein handheld communications device 36 is a smartphone, such as a Blackberry Curve or the like, handheld communications device 36 employs a first data communication modality 48, such as a General Packet Radio Service (GPRS), 1xEV-DO or other wireless data connection to communicate with data communications network 44 and a second data communication modality 52, such as a Bluetooth, WiFi or other wireless data connection to command server 32.

As will be apparent to those of skill in the art, handheld communications device 36 can also provide and/or employ additional communications modalities, such as GSM or CDMA voice services, SMS text messaging, email, WiFi, WiMax, etc. and appropriate ones of these modalities can be employed with system 20 as well as, or instead of, first data communication modality 48 and second communication modality 52. For example, first communications modality 48 can be achieved by SMS messaging and second communications modality 52 can be achieved via WiFi, although the use of high speed data communications services such as GPRS or 1xEV-DO or the like are preferred for first communications modality 48 and Bluetooth is presently preferred for use as second communication modality 52. Similarly, first communication modality 48 and second communications modality 52 can each be WiFi connections, with handheld communications device 36 communicating directly with command server 32 and indirectly, through personal computer 28 or a WiFi access point (not shown), with data communications network 44 and account server 24.

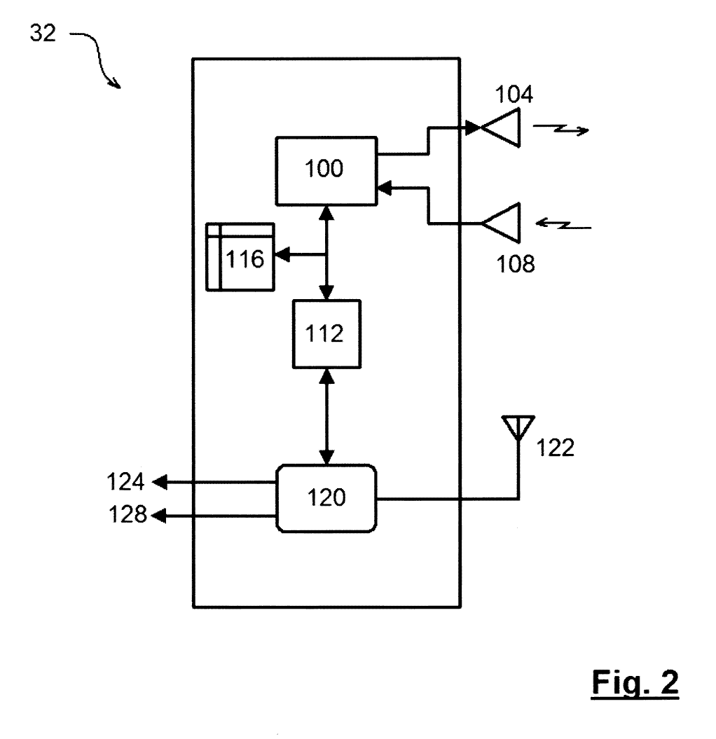

An embodiment of command server 32 is shown in more detail in FIG. 2. Command server 32 includes an IR transceiver 100 which is operably connected to at least one IR transmitter 104 for producing IR command signals and, preferably, to at least one IR receiver 108 which can be used to received IR command signals transmitted from other devices.

In a present embodiment of command server 32, IR transceiver 100 is a Crimzon™ microcontroller, manufactured by Zilog, 6800 Santa Teresa Blvd., San Jose, Calif., USA. In addition to communicating with other components of command server 32 through a bus or other suitable means, the Crimzon™ device includes memory to store data representing IR commands, appropriate circuitry to create IR signals from stored data for transmission from IR transmitter 104 and appropriate circuitry to receive transmitted IR commands, via IR receiver 108, and to analyze those received commands to learn and store data to represent those new commands.

While the use of a Crimzon™ microcontroller is presently preferred for command server 32, the present invention is not so limited and any suitable method for creating IR signals can be employed as desired. Further, while it is presently preferred that command server 32 include an IR receiver 108 for learning new commands and/or monitoring commands sent between other devices, the present invention is not so limited and it is contemplated that command server 32 can be constructed without IR receiver 108 if desired.

It is also contemplated that command server 32 can include one or more command transmitters/transceivers (not shown) which employ other communication modalities, such as HomeRF, Zigbee, X10 or other AC power line based transceivers or other communications protocols and modalities to control devices which do not support IR based control modalities and the memory to store data representing commands in those other modalities. Accordingly, while the description herein primarily discusses IR based control, the present invention is not so limited.

Command server 32 further includes a microcontroller 112, which in a present embodiment is a Z8F0412 microcontroller manufactured by Zilog, and static memory 116 which contains the program executed by microcontroller 112 to implement the functions of command server 32 and other data required within command server 32. Static memory 116 can be provided on microcontroller 112 and/or IR transceiver 100, or can be one or more discrete components within command server 32. The specific configuration of microcontroller 112 is not particularly limited and it is contemplated that other microcontrollers or suitable microprocessors or PIC controllers, as will occur to those of skill in the art, can be used as well. It is further contemplated that the functionality of IR transceiver 100 and microcontroller 112 can be provided by a single device.

Command server 32 further includes a bidirectional communications transceiver 120 which can exchange data with handheld communications device 36 and other devices. In a presently preferred embodiment of the invention, communications transceiver 120 is a Bluetooth transceiver, such as a BlueCore5 transceiver, manufactured by CSR, Unit 400 Cambridge Science Park, Milton Road, Cambridge, CB4 OWH, UK.

However, the present invention is not limited to Bluetooth as the communications protocol/system for bidirectional communications transceiver 120 and any suitable communications modality (including non-radio modalities) and protocol, as will occur to those of skill in the art, can be employed as desired. For example, bidirectional communications transceiver 120 can employ WiFi (802.11x) or Zigbee (802.15.4) communications standards, or the like, provided only that handheld communications device 36 has a corresponding capability of communicating with command server 32 via bidirectional communications transceiver 120. Depending upon the wireless communication modality employed, command server 32 can include an antenna 122 which may be external or internal to the enclosure of command server 32 depending upon the frequency and/or protocol of the wireless communication modality.

Even when bidirectional communications transceiver 120 employs a radio, or other wireless, communication modality, it is contemplated that command server 32 can also include a wired Ethernet (802.3) network interface, a WiFi (802.11x) or WiMax (802.16x) network interface (not shown) to permit other devices to communicate with command server 32.

As mentioned above, in the present embodiment of command server 32, bidirectional communications transceiver 120 is a BlueCore5 Bluetooth transceiver. Some models of this device provide multimedia processing, such as playback of digital music files encoded with MP3 compression, and as such, in this embodiment command processor 32 further includes Left 124 and Right 128 audio outputs which can provide audio signals to a connected audio receiver or amplifier. If the particular device selected to provide the functionality of bidirectional communications transceiver 120 does not provide multimedia processing, and if such functionality is desired in command server 32, then an additional multimedia processor (not shown) can be included in command server 32.

The setup and operation of system 20 will now be described with reference to the control of at least television set 40a and audio receiver 40b and wherein handheld communications device 36 is a smartphone, such as a Blackberry Curve™ or Apple iPhone™.

Initially, a user will purchase, or otherwise obtain, a command server 32 and will connect to an account setup application running on, or in conjunction with, account server 24. As mentioned before, preferably the account setup application is html based and the user can access the application through personal computer 28 or via a web browser on a handheld communications device 36 which is so enabled.

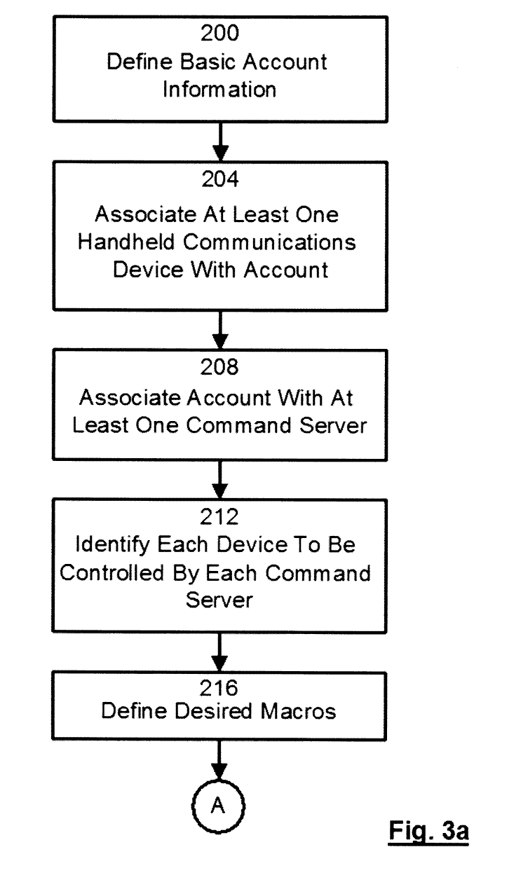

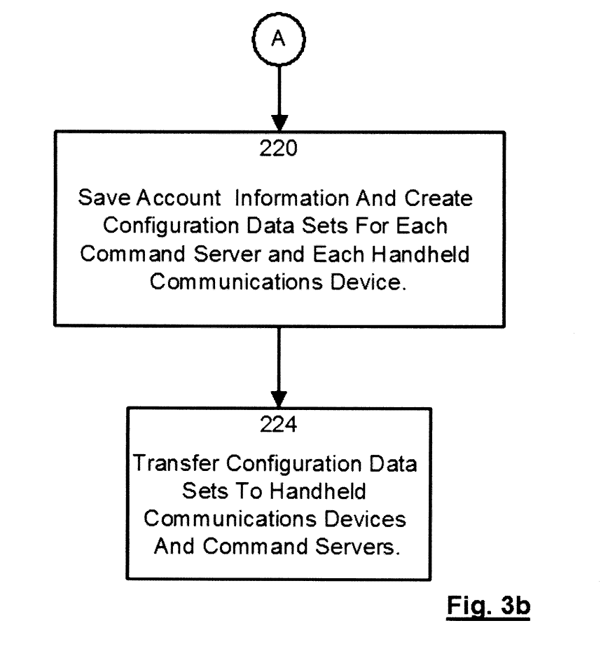

The process of account setup is discussed with reference to the flowcharts of FIGS. 3a and 3b. The method commences at step 200 with the display of one or more screens to the user and the acceptance of input from the user to define basic account information, such as selecting a username or other account identifier for the account and selecting or being assigned a password for the account. Alternatively, an account identifier can be pre-associated with, and provided with, command server 32. The set up of such basic account information can be accomplished in a wide variety of manners, as will occur to those of skill in the art, and the present invention is not limited to any particular method or arrangement.

Next, at step 204 at least one handheld communications device 36 is associated with the account. As handheld communications device 36 can be a smartphone or other personal communications device, it is contemplated that several users in a household, or other location, will have handheld communications devices 36 with which they wish to control various devices 40. Accordingly, system 20 permits multiple handheld communications devices 36 to be associated with an account such that each individual can control devices 40 as desired. Each handheld communications device 36 will have a unique identifier, such as a MAC Address, IMEI, PIN number or other suitable identifier which is used to associate the handheld communications device 36 with the account. As should be apparent to those of skill in the art, each handheld communications device 36 associated with an account need not be of the same type nor from the same manufacturer. For example, an account can have one or more Blackberry Curves and one or more Apple iPhones associated with it and the particular handheld communications devices 36 can have different capabilities and features, i.e.—a touch screen, a trackball input, etc.

Next at step 208, assuming that the account has not been pre-associated with command server 32, the account is associated with at least one command server 32. Presently, each command server 32 is assigned a unique identifier code as part of the manufacture process. This identifier code is input into the account setup application to associate the command server 32 with the account. As discussed in more detail below, it is contemplated that users can obtain two or more command servers 32, one for use in each of different rooms in their home, for example. In such a case, each command sever 32 will preferably be associated with a single account for that user, or household, and such additional command servers 32 can be associated with the account at step 208.

Next, at step 212, the user inputs into the account a suitable identifier for each device 40 which is intended to be controlled with one or more command servers 32 associated with the account. For example, for the embodiment shown in FIG. 1, the user would input suitable identifiers for television set 40a and for audio receiver 40b. For many consumer electronics devices, it is contemplated that the input of identifiers will be an interactive process employing dynamically formatted drop down lists.

Specifically, in a present embodiment, the user is presented with a first selection of categories of consumer electronics devices, such as “Televisions”, “AV Receivers”, “Audio Receivers”, “DVD Players”, “Home Lighting Devices”, etc., to choose from. Once the user has selected the appropriate category (e.g.—“Television” for television set 40a) the user is prompted to identify the manufacturer of the television set. Once the user has selected (or input) the correct manufacturer of their device (e.g.—television set 40a), the user is then prompted to input (or select) the model number or other identifier of their device. If any additional identifying information is required to correctly identify the device, the user is then prompted for this information.

Once a device 40 has been properly identified within the account, account server 24 determines if an appropriate set of data representing commands for that device is available to system 20. Specifically, system 20 will have already been populated with command set (IR, RF or other appropriate command sets) data for many popular consumer electronics devices. Such data can be acquired from a variety of sources, including direct from the manufacturers of the consumer electronics devices, from the supplier of IR transceiver 100, etc. If system 20 does not have available command set data for a specified device, the user will be informed that command server 32 must Learn the necessary commands for the identified device and the user will be advised on how to achieve this, as described below.

If the more than one command server 32 is associated with the account, as each device 40 to be controlled is identified to system 20, the user indicates which command server 32 is to control that device 40. For example, if a first command server 32 is located in the user's living room and a second command server 32 is located in the user's family room, when the user identifies the television set in his living room to system 20 he also indicates to system 20 that the command server 32 in the living room should control this device. Similarly, when he identifies the television set in his family room to system 20 he also indicates to system 20 that the command server 32 in the family room should control this device.

Once each device 40 to be controlled by each command server 32 has been identified to system 20, the process continues at step 216 wherein any desired macro programs can be defined to system 20. Specifically, the user can create sets of organized sequences of commands, commonly referred to as macros, to control one or more devices 40. For example, a macro can be defined which places a home theatre system into a suitable configuration for watching a DVD movie. Such a macro can contain commands to: turn on a television and set it to use a suitable input (Composite In or HDMI); turn on a DVD player; turn on a surround sound system and set it to use a DVD input; etc. A user selected icon and/or name can also be associated with a macro, that icon and/or name being displayed to the user on handheld communications device 36, as described in more detail below. The use of macros with remote control systems is well known and need not be described in detail herein.

Next, at step 220, the account setup data is saved and processed to create an appropriate configuration data set for each of command servers 32 and for each of handheld communications devices 36 included in the account. These configuration data sets are compiled from the input account information and from data available on account server 24 and elsewhere. The configuration data set for each command server 32 includes at least any necessary command data (such as IR command definitions, etc.) that will be required for the command server 32 to appropriately control the devices 40 associated with it, along with any defined macros or other related information.

The configuration data set for each handheld communications device 36 includes at least the necessary data for handheld communications device 36 to interoperate with the command servers 32 associated with the account. Specifically, the configuration data set for handheld communications device 36 will include a remote control application and user interface to be executed on the handheld communications device 36 and any additional data, such as macros, icons, names and labels or other related information required.

At step 224, the configuration data sets created at step 220 are appropriately downloaded into the command servers 32 and handheld communications devices 36 and configuration of system 20 is complete.

The configuration data set for each handheld communications device 36 can be downloaded either through a wireless connection (GPRS, 1xEV-DO, etc.) 48 between the respective handheld communications device 36 and data communications network 44 or indirectly by first downloading to personal computer 28 and then to the respective handheld communications device 36 via a wired connection (Ethernet, USB, etc.) or a wireless connection (WiFi, Bluetooth, etc.)

In the embodiment illustrated in FIG. 1, command server 32 does not have a direct connection with data communications network 44. Accordingly, in this embodiment, the configuration data set for each command server 32 will be downloaded to at least one of the handheld communications devices 36 associated with the account, either through a wireless connection (GPRS, 1xEV-DO, etc.) between handheld communications device 36 and data communications network 44 or indirectly by first downloading to personal computer 28 and then to handheld communications device 36 via a wired connection (Ethernet, USB, etc.) or a wireless connection (WiFi, Bluetooth, etc.).

Once the configuration data set for a command server 32 is loaded into a handheld communications device 36, it can be transferred to the appropriate command server 32 via second data communication modality 52 (for example Bluetooth).

In other embodiments of the present invention, wherein command server 32 includes a connection to data communications network 44 (such as by wired Ethernet or via WiFi) the downloading of configuration data sets to a command server 32 can be performed directly or, where command server 32 can be connected to personal computer 28 (for example by USB), the configuration data set can be downloaded to personal computer 28 and then transferred to command server 32.

Once an appropriate configuration data set has been loaded into a command server 32, that command server 32 can operate as part of system 20 to control devices 40 as described below. Similarly, once an appropriate configuration data set has been loaded into a handheld communication device 36, that handheld communications device 36 can operate as part of system 20 to control devices 40 as described below.

As should be apparent to those of skill in the art, desired portions of the above-described set up and configuration of an account for system 20 can be performed again to reconfigure system 20 in the event that: command servers 32 are added to, or removed from, system 20; handheld communications devices 36 are added to or removed from system 20; devices 40 to be controlled by system 20 are added or removed; as users wish to create, alter or remove macros from system; etc. In each case, once changes are effected to the user's account, appropriate configuration data sets are created by system 20 as needed and are transferred as needed to handheld communications devices 36 and/or command servers 32 in system 20, as described above, to reflect those changes.

If when configuring an account in system 20 a user identifies a device 40 (an “unknown device”) for which system 20 does not have relevant command set data (IR codes, available functions, etc.) system 20 will guide the user through a learning process to discover relevant command data set and other information for that device. This learning process is similar to known processes used by learning universal remote controls except that the learning process is achieved by the combination of cooperating processes executing on command server 32 and on handheld communications device 36.

Specifically, an application for controlling the learning process is loaded into handheld communications device 36 (which has been previously identified to system 20) from account server 24 via first data communications modality 48 or, indirectly by transferring the application to personal computer 28 and then to handheld communications device 38. This application is executed on handheld communications device 36 and provides suitable prompts directing the user to perform the learning process and to interact with a command server 32 to perform the learning process.

During the learning process, the user is instructed by one or more prompts displayed on handheld communications device 36 to place the manufacturer-supplied remote control unit for the unknown device 40 adjacent to command server 32 such that IR receiver 108 can receive IR signals from the remote control unit.

Next, the user is prompted by handheld communications device 36 to activate a key on the remote control unit to transmit an IR code to IR receiver 108 to control a function of device 40. Handheld communications device 36 also sends a command, over second data communication modality 52, for IR transceiver 100 to commence a “learning” operation for a signal received at IR receiver 108.

The user then activates the key on the manufacturer-supplied original remote that they were prompted to press and the command is transmitted by the original remote control to command server 32. The command is received at IR receiver 108 and is processed by IR transceiver 100 to learn the respective code. If the command has been successfully analyzed by IR transceiver 100, a signal to that effect is transmitted from command server 32 to handheld communications device 36, along with an appropriate data representation of the learned command which can be used to recreate the command, over second data communications modality 52. In this case, handheld communications device 36 will prompt the user to press the next key on the remote control to perform the learning process for this next function.

Conversely, if the command received at IR receiver 108 could not be meaningfully analyzed by IR transceiver 100 (either due to poor positioning of the remote control with respect to IR receiver 108, too much or too little distance between the remote control and IR receiver 108, etc.) command server 32 will send a signal, representative of this result, to handheld communications device 36 over second data communications modality 52. Handheld communications device 36 will prompt the user to again press the desired key on the remote control and/or will ask the user to reposition command server 32 or the original remote control to improve the transmission of the signal. The command will be received at IR receiver 108 and processed as described above.

Once the desired commands for the unknown device 40 have been learned and appropriate data representations of the learned commands, which can be used to recreate the commands, have been transferred to handheld communications device 36, the learning application executing on handheld communications device 36 will transfer those representations of the learned commands to account server 24 via data communications network 44, either directly or indirectly as described above.

The received command representations are added to the database of devices and commands maintained at account server 24 and can be used to control the previously unknown device 40 in system 20. If the learning process was initiated as part on an initial account setup, the learned commands will be included, as appropriate, in the configuration data sets sent to command servers 32 and handheld communications devices 36 in system 20. If the learning process was initiated as part of a reconfiguration of system 20 to add a new device 40, then account server 24 will create updated configuration data sets for command servers 32 and/or handheld communications devices 36, as needed, and will transfer those updated configuration data sets to command servers 32 and/or handheld communications devices 36 as described above.

One of the advantages of system 20 is that commands sets which are learned by a user for previously unknown devices are stored in account server 24 and will subsequently be available to other users configuring other accounts on system 20. Thus, it is contemplated that a learning process need only be performed the first time system 20 encounters an unknown device 40.

It is also contemplated that the user interface capabilities of handheld communications device 36, which can include a complete keyboard, a color display screen, a mouse, a touchscreen or trackball etc. and the capability of real time bi-directional communications between handheld communications device 36 and command server 32 result in a simplified learning process, compared to prior art learning remote controls, and provide a commensurate likelihood that a user can successfully perform the process within minimal difficulty.

In use, system 20 provides a flexible, robust and powerful system and method of controlling a variety of devices 40. Specifically, once each command server 32 and each handheld communications device 36 associated with an account is properly configured, a user can control any device 40 defined for his account.

To do so, the user invokes the remote control application which was previously downloaded to handheld communications device 36 as part of the configuration data set. Depending upon the capabilities of handheld data communications device 36, this invocation may require initiating and/or executing the remote control application or may merely require switching context back to the already running remote control application or resuming the remote control application.

Once the remote control application has been appropriately invoked, a relevant user interface is displayed to the user on handheld communications device 36. The specific features of the user interface which are displayed will depend upon the devices 40 which are controllable by system 20 and, to some extent, user selections. For example, if system 20 has been configured to control a television set and a surround sound receiver, commands relevant to the use of those devices can be displayed to the user. If system 20 has also been configured to control air conditioning and lighting systems, commands relevant to those devices can also be displayed to the user. Further, the commands can be arranged into a convenient system, or a user-defined, hierarchy, as is well known.

It is contemplated that most users will have a personal handheld communications device 36 which they maintain on or about their person throughout much of the day as they move between various locations. This is believed to be particularly true when handheld communications device 36 is a smartphone or the like.

In such a case, wherein handheld communications device 36 moves between various locations, and if system 20 includes two or more command servers 32, the particular command server 32 which the user desires handheld communications device 36 to interact with must be determined. For example, in the above-mentioned example of a user with a command server 32 in their living room and a command server 32 in their family room, system 20 must determine which command server 32 (i.e.—living room or family room) a command initiated by the handheld communications device 36 is intended for.

In one embodiment of the present invention, a proximity test is used to automatically determine the intended command server (the focus) of commands initiated by a handheld communications device 36. Specifically, handheld communications device 36 will, at appropriate intervals, determine which command server 32 is located closest to it. Such a proximity determination can be performed in a wide variety of manners, as will be apparent to those of skill in the art. In a present embodiment of system 20 wherein second communications modality 52 is a Bluetooth data connection, the received signal strength of the Bluetooth RF signal can be analyzed to determine an estimated distance between handheld communications device 36 and each command server 32 with which it can communicate.

Once handheld communications device 36 has determined the closest command server 32, handheld communications device 36 will communicate with that determined closest command server 32, unless explicitly commanded to change to another command sever 32 or until another proximity determination is performed which indicates that handheld communications device 36 is now closer to another command server 32. The command server 32 with which a handheld communications device 36 will communicate is referred to herein as the command server which has the “focus” of handheld communications device 36. In a presently preferred embodiment, the user interface of the remote control application executing on handheld communications device 36 will indicate the command server 32 in the focus of handheld communications device 36, i.e.—the command server which commands will be sent to.

This indication can be achieved in a wide variety of manners, as will be apparent to those of skill in the art, including, without limitation: an appropriate text label (e.g.—“Living Room”) displayed on handheld communications device 36; the use of different screen colors, icons, screen layout, etc. (i.e.—themes) on the display of handheld communications device 36 for each command server 32 and changing those themes as the focus changes; etc.

As mentioned, it is contemplated that in some cases a user may wish to explicitly select the focus command server 32 for the user's handheld communications device 36. For example, the user may have moved from the living room to the family room in the midst of watching a television program and may wish to turn off the television set in the living room without having to leave the family room. In such a case, the user interface of the remote control application will allow the user to explicitly set the focus of the user's handheld communication device 36 to the command server 32 in the living room. The user can then select and send a command to that command server 32 to turn off the television set in the living room. When this step is completed, the user can reset their remote control application to again automatically determine and set the focus of their handheld communications device 36 to the closest command server 32.

In a preferred embodiment of the invention, when the focus of handheld communications device 36 is set on a particular command server 32, either automatically or explicitly, the user interface of the remote control application can update to display only those commands which are relevant to devices 40 which the command server 32 that is in focus operates with. For example, in the above-mentioned example of system 20 including a command server 32 in the user's living room and a command server 32 in the user's family room, if a handheld communications device 36 has determined that the command server 32 in the family room has the focus, then the user interface of the remote control application on that handheld communications device 36 will display commands which are relevant to the television set to be controlled.

Conversely, if the handheld communications device 36 has determined that the command server 32 in the living room has the focus, then the user interface of the remote control application on that handheld communications interface will display commands which are relevant to the home theatre system to be controlled.

As will be apparent to those of skill in the art, each handheld communications device 36 associated with the user's account in system 20 can have a different command server 32 in focus, as handheld communications devices 36 are located in different areas (in a house or other location) served by system 20, or two or more handheld communications devices 36 can have the same command server 32 in focus.

When a user selects a desired command to be executed from the user interface of the remote control application executing on a handheld communications device 36 a control command, representing the selected command, is transmitted over second data communications modality 52, from handheld communications device 36 to the command server 32 which presently has the focus of the handheld communications device 36. This command server 32 processes the received control command, in view of its configuration data set, and determines the corresponding device 40 for which the command is intended and the actual command which needs to be transmitted for the desired result at the corresponding device 40. The command server 32 then transmits the determined command to the corresponding device 40.

In a present embodiment of the invention, meta commands are preferably employed as control commands between handheld communications device 36 and command server 32. These meta commands are in the form of bit mapped data packets, or any other suitable format as will occur to those of skill in the art, that indicate a desired category of device (i.e.—“Television”, “Audio Receiver”, etc.) and a desired command (i.e.—“Activate Device”, “Channel Up”, “Channel Down”, etc.). Thus, a command server 32 may receive a meta command representing a command to change the channel of a television set to the next higher channel.

When a command server 32 receives a meta command, it consults the configuration data set in its memory to correspond the indicated category of device to a specific device 40 (or devices 40) which is associated with it and to then determine the required command signal, or command signals, which it must transmit to the determined device 40 to achieve the desired result.

While many meta commands relate to a specific device 40, in the present invention meta commands are not so limited and macro-like meta commands can be employed as well. For example a meta command can be employed which corresponds to an “All Devices OFF” command. In such a case, the command server 32 receiving such a meta command will determine the correct commands it must transmit to turn off all devices 40 which it is associated with and will transmit that set of commands.

While not essential to the present invention, the use of such meta commands provides numerous advantages to system 20. In particular, the remote control application need only employ a single set of meta commands to appropriately control all devices 40 associated with system 20. The same meta command representing a desired “Television Off” command will be received and appropriately processed by all command servers 32 which have a television device 40 associated with them, despite that fact that different models of televisions are associated with different command servers 32 and different actual commands will be transmitted by the command servers 32.

One of the functions available to microcontroller 112 is a real time clock. Accordingly, command servers 32 can receive control commands which are to be deferred until a user specified time. For example, a user can specify that a television set is to be turned on at 8:00 PM as a reminder to the user that a sporting event they wish to watch is to start at that time. In this case, the control command to turn on the television set will further contain a time at which the command is to be executed.

In another example, the user can desire to record a television broadcast which occurs at a known time. In this case, the command server 32 can receive control commands which turn on the recording device and properly configure it (set the desired correct channel, commence the recording process, etc.) and which are deferred until the proper time to start the recording. The command server 32 can also receive control commands to stop the recording process and turn off the recording device and these commands will be deferred to the end time of the broadcast.

It is expected that a variety of other uses for time-deferred commands will occur to those of skill in the art, such as commands to activate or deactivate household lighting systems, etc.

One of the perceived advantages of the present invention is that second data communications modality 52 is bi-directional. This allows system 20 to operate in a variety of potentially advantageous manners.

One of these advantageous operating manners is that system 20 can determine the status of users within system 20. For example, system 20 can determine if a user is within a location served by system 20 (the living room or family room in the above-mentioned example) or is outside the location server by system 20 (at the user's office, etc.). As each user of system 20 can have a particular handheld communications device 36 associated with them, system 20 can have each command server 32 attempt to communicate with a handheld communications device 36 to determine if a particular user is within the service bounds of system 20. This ability to determine a user's status can assist in providing a variety of unique and advantageous operating modes.

For example, a user can define an “Alert” within system 20 to remind the user of the start of a particular Television program that the user wishes to watch. As the preset time for the Alert approaches, system 20 can determine if the user that set the Alert is within communications range of a command server 32 which has a television device 40 associated with it. If the particular user is within communications range of a command server 32 which has a television set associated with it, at the appropriate time system 20 can turn on that television set (if the television set is not already turned on) and can change it to the preset channel of the program the user desired to watch.

Conversely, if system 20 determines that the user is not within communications range of a command server 32 which has a television set associated with it, then the handheld communications device 36 can provide a suitable reminder (e.g.—an audio beep and/or pop up message on the handheld communications device 36) to the user reminding them of the imminent start of the program.

System 20 can also be configured to have a command server 32 automatically issue commands to activate a recording device 40 (such as a PVR) to record the program, if the user associated with the handheld communications device 36 is not watching the program, or the suitable reminder displayed to the user on handheld communications device 36 can include an option for the user to initiate such a recording operation. In this later case, assuming the user is not within communications range of a command server 32, the user's selection of this option can be communicated to account server 24 via first communication modality 48 and account server 24 can forward the selection of the option to an appropriate command server 32 (i.e.—a command server 32 which is associated with a recording device, such as a PVR) by forwarding the appropriate data to another handheld communications device 36 which is within range of a command server 32, for forwarding to the command server 32 via second communications modality 52, or directly via data communication network 44 if the command server 32 is capable of communications in this manner.

A variety of other Alerts and behaviors, as will occur to those of skill in the art, can be defined within system 20.

The bi-directionality of second communications modality 52 can provide a number of other advantages. For example, if a command server 32 receives a control command from a handheld communications device 36 which is received in a garbled state, or which command server 32 does not know how to properly process, a suitable error message can be transmitted, via second communications modality 52, from command server 32 to handheld communications device 36. Upon receipt of such a message, the remote control application executing on handheld communications device 36 could automatically resend the control command that was garbled or could display a suitable error message to the user who could take appropriate steps, such as to reconfigure their account, on account server 24, to address the error.

Also, command servers 32 can operate to transmit a confirmation signal over second communications modality 52 to the handheld communications device 36 to confirm that a control command has been properly received. Thus, in such an embodiment, each time handheld communications device 36 transmits a control command to a command server 32, it expects a confirmation signal that the control command has been properly received. If such a confirmation signal is not received at the handheld communications device 36, the handheld communications device 36 can retransmit the control command.

Further, if the focus of a handheld communications device 36 is explicitly or automatically (and incorrectly) set to a command server 32 which is not the most proximal to the handheld communications device 36, the possibility that a control command (or confirmation signal) sent between handheld communications device 36 and that command server 32 over second communications modality 52 will not be successfully received increases.

In such a case, after the remote control application has failed to receive one or more appropriate confirmation signals from that command server 32, the remote control application can cause handheld communications device 36 to switch focus to another, preferably the most proximal, command server 32 and to transmit the control command to that command server 32 packaged in a request that that command server 32 rebroadcast the control command to the originally selected command server 32 and to forward any confirmation signal received from the originally selected command server 32 back to handheld communications device 36. In this manner, command servers 32 can operate as a form of mesh network, effectively increasing the range over which a handheld communications device 36 can communicate with a command server 32 via second communications modality 52. It is contemplated that command servers 32 can operate to provide the functionality of many known mesh networks and can benefit from the availability of such a mesh network configuration.

Each command server 32 can also operate to maintain a record of the last known state of devices 40 associated with it and this state record can be provided to the remote control application executing on handheld communications device 36, over second communications modality 52, as desired. Thus, a user can consult the user interface of the remote control application to determine the operating state of one or more devices 40 in system 20. For example, a user can determine if a television set has inadvertently be left on in another room, etc.

Further, this record of the current state of the devices 40 in system 20 can allow command servers 32 to implement conditional, or adaptive, macros which are automatically adjusted to correspond to the state of the devices 40. For example, a macro to watch a DVD will include a step to turn on the TV connected to the DVD player and to switch the TV to the correct input for the DVD player, etc. If, when the macro to watch a DVD is activated, the record of the current state of the TV device 40 indicates that it is already turned on, the macro will skip the step of turning the TV on and will only perform the steps necessary to correctly configure devices 40 to allow the user to watch a DVD.

If desired, command servers 32 can maintain logs of various events and/or activities and these logs can be transferred to account server 24, or other devices connected to data communications network 44. If command servers 32 do not have a direct connection to data communications network 44, the logs can first be transferred to handheld data communications device 36 via second data communications modality 52 and then to data communications network 44, either directly or via personal computer 28. The logs can record information such as when devices 40 were activated or deactivated, and by which handheld communications device 36. The logs can also record which television channels were watched at which times of the day, which radio stations were listened to, etc. The logs can also record which handheld communications devices 36 where in proximity to a command server 32 and this can allow an inference to be made about which users were involved in an activity, such as watching a DVD, etc.

It is contemplated that these logs, or relevant subsets of them, can be made available to the user as part of the information associated with their account information on account server 24. For example, these logs can be used by a parent to monitor their child's viewing habits, provided that their child has a handheld communications device 36 which is part of system 20.

It is also contemplated that portions of these logs, for example the information with respect to which television channels were watched and when and by whom, can be user for a variety of other purposes. In particular, as information, such as demographic information, is known to system 20 for the user of each handheld communications device 36 (having been input as part of the account set up process), these logs can be used to provide analytics with respect to the activities of a user. For example, the logs can indicate that a specific user switched to a channel on a TV at a particular time and that the TV remained on that channel until that user switched to a different channel at a later time. The logs can also indicate that another user (of a different handheld communications device 36) was also in proximity to the command server 32 that controlled the TV and thus, it can be assumed that this other user was also watching the TV. This can, for example, allow a TV ratings company to better understand who is watching what programs and when.

Further, the granularity of the logs can be very fine, allowing a ratings company to determine if a user, or even which user, changed the channel during a commercial, or muted the commercial, etc.

Another advantageous aspect of the present invention is that it allows a user to control one or more devices 40 indirectly. Specifically, a user can log into account server 24 and can issue a command to a device 40 controlled by system 20. If command servers 32 have a direct connection to data communications network 44, then the command issued by the user will be forwarded to the command server 32 associated with the device 40 that the user wishes to control. That command server 32 will then transmit the desired command to the device 40. For example, a user can log into his account from his office and issues commands to turn on lighting at his home.

If command servers 32 do not have a direct connection to data communications network 44, the account server can query each handheld communications device 36 associated with the user's account to determine if one or more of those handheld communications devices 36 is within communication range of a command server 32. If a handheld communications device 36 is within communications range of a command server 32, then the issued command is sent to the handheld communications device 36 via first communications modality 48 and is forwarded to the command server 32, via second communications modality 52, by the handheld communications device 36.

If no handheld communications device 36 is within range of a command server 32, the user can be so informed and the user can either decide to retry their command request later, or can queue the desired command in account server 24 such that the command is transmitted to the command server 32 when a handheld communications device 36 moves into range of command server 32. In this latter case, account server 24 will recheck, from time to time, to see if a handheld communications device 36 has moved into range of a command server 32 to enable transfer of the issued command and will transmit the command to the handheld communications device 36 which first moves into range.

It is also contemplated that the user can use such access to account server 24 to check the state of various devices 40 controlled by system 20. Specifically, as discussed above, command servers 32 can maintain a record of the state of devices 40 associated with them. These records of the state can be forwarded to account server 24, either at pre-specified time intervals or upon request, allowing the user to check the state of devices 40 controlled by system 20.

It is also contemplated that the user can use such access to account server 24 to issue deferred commands to record television broadcasts or the like, as described above. Thus, a user can program activities, such as the recording of television broadcasts, from a remote location such as a business office and have those commands forwarded to and processed, as appropriate, by a command server 32.

As shown in FIG. 2 and discussed above, in one embodiment command server 32 includes a Left 124 and Right 128 audio output as well as multimedia processing capabilities. It is contemplated that Left 124 and Right 128 audio outputs can be connected to appropriate inputs on an audio receiver or amplifier. Thus, audio files stored on handheld communications device 36 in MP3 or other digital format can be streamed to command server 32 over second communications modality 52. The received streams can be processed by the multimedia processor in command server 32 and output to the audio receiver, or other audio device, via Left 124 and Right 128 audio outputs, thus allowing system 20 to act as an audio media server. In such a case, an appropriate user interface will be executed on handheld communications device 36 allowing a user to select from available files on the handheld communications device 36 and to play, fast forward, rewind, pause, etc. the audio playback. This audio media server user interface application will appropriately interface with the remote control application to allow the user to control the audio device used to play the audio files, including turning the audio device on or off and altering the volume of the device, etc.

If handheld communications device 36 is a smartphone, system 20 can be configured to interoperate with the other functions of the smartphone as desired by the user. For example, if the user is watching a movie in their home theater when a telephone call is received on the smartphone handheld communications device 36, the remote control application executing on the smartphone handheld communications device 36 can automatically issue commands to mute and/or pause playback of the movie when the user accepts the incoming call. When the user completes the call, the remote control application can automatically issue commands to unmute and/or resume playback of the movie.

It is contemplated that the specific interactions (i.e. mute movie when accepting a call, pause movie when accepting a call, pause audio playback of streaming music when accepting a call, etc.) between the smartphone and remote control application can be specified as desired by the user as part of the set up of their account on account server 24. Further, the desired interactions can vary from command server 32 to command server 32. For example, while the user may wish to pause and/or mute movie playback on the home theatre in the living room when receiving a call, the user may not wish to mute a program on the television on the family room when receiving a call in the family room (as determined by the above-mentioned proximity determination). The set up of such automatic interactions of the smartphone handheld communications device 36 can be defined by the user in their account on account server 24 and implemented in the configuration data set which is downloaded into the smartphone handheld communications device 36 as described above.

It is also contemplated that a handheld communications device 36 and a command server 32 can interoperate to provide enhanced functionality features by providing features to devices 40 which are not inherently provided by the manufacturer of the device 40. For example, many devices 40 such as an Apple TV or Sony Playstation III provide very limited means for inputting text or other data into the device 40. When such devices require the user to input text, they commonly provide a display of the alphabet and require the user to navigate with Up, Down, Left and Right commands to move a cursor to highlight a letter to be input. When the user has highlight the desired letter, they then press a select button to enter that letter. As will be apparent, for activities which require anything beyond the shortest text strings, this quickly becomes tedious for the user.

In the present invention, handheld communications device 36 can include a full keyboard (such as a QWERTY keyboard). If, at a text input operation on a device 40, the user presses a key for a letter on the keyboard of handheld communications device 36, handheld communications device 36 can transmit a control command to input that selected letter to command server 32 (i.e.—a meta command such as “APPLE TV”, “Input Text ‘S’”). Upon receipt of such a meta command, command server 32 can transmit the corresponding appropriate set of appropriate navigation commands (e.g.—Right, Down, Select) to highlight and select the desired letter (e.g.—“S”). As will be apparent to those of skill in the art, command server 32 can maintain a record of the position of the cursor, as the navigation commands are relative the start position of the cursor, or can explicitly return the cursor to a known location before executing such a Text Input meta command. In the former case, command server 32 will dynamically determine the set of appropriate navigation commands to move the cursor from its present location to its desired location.

Other examples of such enhanced functionality can include adding voice recognition capabilities. Specifically, many handheld communications devices 36, especially smartphones, provide at least some level of voice recognition functionality. In system 20, handheld communications device 36 can issue one or more control commands corresponding to voice commands from the user which are recognized by handheld communications device 36. For example, the user watching a DVD with devices 40 could give a voice command to handheld communications device 36 to “pause”. Handheld communication device 36 can then, upon recognition of the “pause” voice command, transmit a control command to pause DVD playback and the command server 32 will receive that “pause” control command and will transmit the appropriate command to DVD player device 40.

The enhanced functionality provided by system 20 can include other instances of mapping, or translation, of haptic devices and methods available on handheld communications device 36 to devices 40. For example, handheld communications device 36 can include a trackball or mouse (for example, implemented by the combination of a touchscreen and stylus) and user interaction with these other input devices and/or methods can be translated or mapped to appropriate control commands and transmitted from handheld communications device 36 to command server 32. Command server 32 can then transmit appropriate commands to devices 40 to respond to the user inputs. For example, if handheld communications device 36 is a BlackBerry Curve device, the user can scroll the Blackberry's trackball up or down to increase or decrease the volume of a television or audio receiver and/or can scroll the trackball left or right to increase or decrease the channel that a television or radio receiver is tuned to.

Another unique feature of the present invention is the ability for a user to record a macro. While macros are well known in the field of remote controls, generally the user must program the macros into the remote control. To date, successfully programming macros has proven difficult for many user. Further, difficulties occur with macros in many cases as the multiple commands of the macro must be transmitted with suitable pauses between them to allow the devices being controlled to properly interpret and respond to the received commands. The actual time of the pauses required by different devices can vary widely and in many cases it can be very difficult to program a macro which employs the correct pause timings.

In contrast, with the present invention the user of handheld communications device 36 can activate a Record Macro function in the remote control application being executed on handheld communications device 36. Once activated, the user can then input the commands necessary to perform the action that the user wishes to create a macro for. While the user inputs the desired commands, handheld communications device 36 transmits appropriate control commands to command server 32 which, in turn, transmits the corresponding command signals to devices 40. At the same time, handheld communications device 36 is recording the commands input by the user, and their relative timings. When the user has completed the input of the commands for the macro, the Record Macro function is deactivated on handheld communications device 36 and the input commands, and their relative timings, are stored as a macro. The stored macro can have an appropriate name assigned to it (i.e.—“Watch DVD”) and the macro can also be assigned to a soft key provided by the remote control application. When the user desires to execute the macro, it is appropriately selected and the macro is “played” by the handheld communications device which transmits each of the stored commands to the command server 32 at the appropriate relative time to place devices 40 in the desired state.

It is also contemplated that recorded macros can be copied to account server 24 if desired. In such a case, other users of an account on system 20 can then access macros recorded by other users. Further, it is contemplated that account server 24 can provide a macro editing facility to allow a user to transfer a recorded macro to account server 24 and to edit that recorded macro, if desired, with account server 24.

Another perceived advantage of system 20 is the ability to provide a program guide to handheld communications device 36 for users. Specifically, as part of the above-described account set up process, a user can specify the information (postal code, service provider—i.e.—cable company or satellite provider, level of provided service, etc.) necessary to identify the television programs available to the user. System 20 will then download an appropriate set of corresponding television program listings to handheld communications devices 36. By employing the user interface elements (color display screens, trackballs, stylus and touch screen, etc.) of the handheld communications devices 36, the user can review the provided program listings as desired. Further, if a user observes a listing of a program currently being broadcast that they wish to watch, the user can select the program from the listing and handheld communications device 36 will issue control commands to command server 32 to display that program to the user. The control commands can turn on the television set, if it is not already on, and can set the television to the appropriate channel.

Similarly, if the user selects a program which is not presently being broadcast, handheld communications device 36 will issue control commands to command server 32 to record that program and command server 32 will perform the corresponding tasks, as described above.

As handheld communications device 36 has first communications modality 48, entries in the programming guide of the present invention can include additional information and/or features. For example, if a selected program has a web site associated with it, the guide can include the relevant URL and, if the user selects the URL, handheld communications device 36 can initiate a web browser session to that web site. As will be apparent to those of skill in the art, a wide variety of other features can be provided. For example, the guide can include URLs for web sites or pages relevant for documentary programs, etc.

The present invention provides a novel remote control system and method for controlling and interacting with a variety of devices and systems. The system comprises at least one command server which is operable to receive control commands from a handheld communications device and to generate and transmit command signals in response to the received control commands, the transmitted command signals interacting with one or more devices controlled by the system. In one embodiment, the handheld communications device is operable to exchange data with an account server that maintains data and configuration information for the system and the devices to be controlled by it over a first communications modality. The handheld communications device transfers control commands and other data with the command server via a second communications modality and the handheld communications device can transfer data between the account server and the command server as needed. The system can support multiple devices to be controlled, multiple command servers, which can each be associated with one or more devices to be controlled, and multiple handheld communications devices.

In a preferred embodiment, the handheld communications device is a smartphone, or the like, which has data communications capabilities, programmable processing capabilities to allow the execution of programs, and user interface elements which allow information to be output to a user and inputs to be accepted from the user.

The above-described embodiments of the invention are intended to be examples of the present invention and alterations and modifications may be effected thereto, by those of skill in the art, without departing from the scope of the invention which is defined solely by the claims appended hereto.

1. A command server for use in a remote control system, the command server comprising:
a memory to store a command server operating program, a configuration data set comprising at least the necessary set of command data to control devices associated with the command server and a record of the operating state of the devices associated with the command server;
a bidirectional communications transceiver operable to exchange data with at least one handheld communications device of the remote control system;
an infrared transmitter to transmit infrared command signals to devices associated with the command server;
a processor executing the command server operating program and operable to, in response to a control command received with the bidirectional communications transceiver from the at least one handheld communications device associated with the command server, determine and transmit at least one corresponding command signal to alter the operating state of at least one device associated with the command server and to update the record of the operating state of the at least one device stored in the memory.

2. The command server of claim 1 wherein the received control command corresponds to an instruction to have the command server execute a macro comprising at least one command signal to be sent to at least one device associated with the command server and the processor adjusts the selection of the at least one command signal to be transmitted to the at least one device associated with the command server in view of the record of the operating state of the devices associated with the command server.

3. The command server of claim 1 wherein, after updating the record of the operating state of the devices stored in the memory, the processor causes the bidirectional communications transceiver to transmit a copy of the updated record to the at least one handheld communications device.

4. The command server of claim 3 wherein at least two handheld communications devices are associated with the command server and, after updating the record of the operating state of the devices stored in the memory, the processor causes the bidirectional communications transceiver to transmit a copy of the updated record to the at least two handheld communications devices.

5. The command server of claim 1 wherein the bidirectional communications transceiver is further operable to exchange data with at least one account server of the remote control system.

6. The command sever of claim 5 wherein the configuration data set is received from the at least one account server and is stored in the memory.

7. The command server of claim 1 further comprising an infrared receiver to receive infrared command signals from remote controls for devices to be associated with the command server, the processor operable to examine received infrared command signals to learn to reproduce the received infrared command signal.
